(19) United States
(12) Patent Application Publication
(10) Pub. No.: US 2008/0193596 A1
(43) Pub. Date: Aug. 14, 2008

(54) Low-Glycemic Mixtures

(75) Inventors: Stephan Hausmanns, Wiesbaden (DE); Joerg Kowalczyk, Eisenberg/Steinborn (DE)

Correspondence Address: DARBY & DARBY P.C., P.O. BOX 770, Church Street Station, New York, NY, 10008-0770, US

(73) Assignee: Suedzucker Aktiengesellschaft Mannheim/Ochsenfurt, Mannheim (DE)

(21) Appl. No.: 11/995,426

(22) PCT Filed: Jul. 18, 2006
(86) PCT No.: PCT/EP2006/007041

§ 371 Date: Mar. 3, 2008

(30) Foreign Application Priority Data
Jul. 18, 2005 (DE) 10 2005 034 043.1

(51) Int. Cl. A23L 2/60; A23L 1/03; A23L 1/48; A23L 1/09; A23L 1/275; A23L 1/302; A23L 2/52

(52) U.S. Cl. 426/61; 426/658; 426/71; 426/601; 426/72; 426/580; 426/590

(57) ABSTRACT

The present invention relates to mixtures and products containing L-carnitine and a low-glycemic sucrose isomer, methods production of same, and uses of the mixtures.

This application is a U.S. national phase application under 35 U.S.C. §371 of International Patent Application No. PCT/EP2006/007041 filed Jul. 18, 2006, which claims the benefit of priority to German Patent Application No. DE 10 2005 034 043.1 filed Jul. 18, 2005, the disclosures of all of which are hereby incorporated by reference in their entireties. The International Application was published in German on Jan. 25, 2007 as WO 2007/009742.

### FIELD OF THE INVENTION

The present invention relates to mixtures containing L-carnitine and at least one low-glycemic sucrose isomer, products containing these mixtures, methods for the production thereof, and uses of the mixtures.

### BACKGROUND

L-Carnitine (3-hydroxy-4-(trimethylammonio)-butyric acid betaine) is a colorless, highly water-soluble substance that serves as a shuttle to carry acyl groups through the mitochondrial membrane, especially in the fatty acid metabolism. L-Carnitine plays an important role in the utilization of fats for the energy production in the body of humans and animals due to the transfer of long-chain activated fatty acids into the mitochondria, where fatty acids are metabolized. The role of L-carnitine in fat metabolism as described here is utilized in a number of foods and luxury foods (e.g., semiluxury foods or stimulants, such as coffee, tea alcohol, chocolate, spices, sugar, and tobacco products) as well as beverages, to provide products with a weight-reducing or at least weight-maintaining effect. For example, WO 97/49304 describes sports and energy beverages containing L-carnitine as one of their ingredients, the consumption of which results in preferential metabolism of energy-rich substrates such as medium- and long-chain free fatty acids.

However, the preferential utilization of fat for energy production in the body as described above may be achieved not only by utilizing the effect of L-carnitine mentioned above, but also by alternate routes. One such alternate route is the use of low-glycemic substances, in particular low-glycemic carbohydrates, which are characterized in that their consumption leads to a comparatively reduced increase in the insulin level in the body, so that oxidation of fat takes places preferentially over oxidation of carbohydrates. Sugars known to be low-glycemic include fructose and isomaltulose, for example. EP 0 652 012 A and WO 97/49304 A have already disclosed mixtures of L-carnitine and fructose in sports beverages.

However, the products containing L-carnitine mentioned above are not perceived as attractive by consumers in terms of their flavor and olfactory properties. This is due to the peculiar sweet taste combined with the faint odor of amine associated with L-carnitine. L-Carnitine is also known to have a decreased stability when combined with certain reducing sugars, e.g., fructose. Finally, beverages containing L-carnitine/fructose are characterized by an osmolality (isotonicity) that should be improved.

The present invention is therefore based on the technical problem of providing mixtures containing these products, methods for the production thereof, and their applications which overcome the disadvantages described above, in particular providing beverages that contain L-carnitine and lead to a greater acceptance by the consumer when used in foods, luxury foods, pharmaceutical drugs or beverages, in particular having improved flavor and olfactory properties and being more stable in storage.

### DETAILED DESCRIPTION

The present invention solves the technical problem on which it is based by providing mixtures containing L-carnitine and at least one low-glycemic sucrose isomer, preferably comprising L-carnitine and one or two low-glycemic sucrose isomers, i.e., comprising in particular L-carnitine and leucrose or comprising L-carnitine and isomaltulose or comprising L-carnitine and leucrose and isomaltulose.

In conjunction with the present invention, a low-glycemic sucrose isomer is understood to be an isomer, i.e., a structural isomer of sucrose that acts as a low-glycemic carbohydrate in the human body, i.e., resulting in a comparatively low respiratory quotient after it is consumed. The respiratory quotient reflects the CO₂/O₂ ratio in the respiratory air and is a measure of which nutrients are being burned. Burning of carbohydrates alone results in a respiratory quotient of 1, whereas burning of fat alone leads to a respiratory quotient of 0.7. Low-glycemic carbohydrates thus passively support the utilization of fat for energy production in the body because they do not cause a great increase in the insulin level and thus they facilitate oxidation of fats.

In conjunction with the present invention, low-glycemic sucrose isomers are understood to preferably refer to leucrose and isomaltulose. The term, “low-glycemic sucrose isomer” in conjunction with the present invention therefore preferably means that a) isomaltulose is provided as a low-glycemic carbohydrate in the inventive mixture containing L-carnitine or b) leucrose is provided in the inventive mixture containing L-carnitine or c) leucrose and isomaltulose are used in the mixture containing L-carnitine, preferably in a ratio of 1:99% by weight to 99:1% by weight, preferably 30:70% by weight to 70:30% by weight (based on the total dry solids content of the two isomers).

The combination of L-carnitine and low-glycemic sucrose isomer, in particular isomaltulose and/or leucrose, in a mixture surprisingly results in the taste of L-carnitine, which is perceived as strangely sweetish by the consumer, being masked by L-carnitine and the resulting mixture having a pleasant sweet taste, in particular also in products produced with this mixture. In addition, the faint amine odor of L-carnitine, which is also perceived as unpleasant by many consumers, is also masked. It has surprisingly been found that isomaltulose in aqueous solutions, i.e., in beverages, provides a very good mask for the bitterness and astringency of L-carnitine, which are perceived as a disadvantage by many consumers, especially in comparison with fructose which has a much lower masking effect on the astringency and bitterness, despite the fact that it is much sweeter per se than isomaltulose. Finally, it has surprisingly been observed that the stability of L-carnitine is greatly increased in the presence of at least one low-glycemic sucrose isomer, in particular isomaltulose, leucrose or a combination of isomaltulose and leucrose, especially also in comparison with mixtures of L-carnitine and fructose. Finally, a better osmolality (isotonicity) of beverages prepared on the basis of mixtures containing L-carnitine and leucrose and/or isomaltulose in comparison with known beverages that contain monosaccharide and L-carnitine.

In conjunction with the present invention, the term “better taste” is understood to mean that a group of test subjects will consider the taste of a product containing isomaltulose and L-carnitine to be pleasantly sweet and will do so to a statistically significant extent in contrast with the peculiar sweet taste of a comparative product containing L-carnitine but without the addition of isomaltulose and/or leucrose.

In conjunction with the present invention, the term “improved aroma” is understood to mean that a group of test subjects will not perceive a faint odor of amine in a product containing isomaltulose and L-carnitine, and these results are statistically significant, whereas the same test subjects do detect the odor of amine in a comparative product containing L-carnitine without the addition of isomaltulose and/or leucrose.

In a preferred embodiment, the inventive mixture is in a solid form, e.g., a grainy, granular, agglomerated, crystalline (in the case of isomaltulose in particular), amorphous (in the case of leucrose in particular), glassy or particulate form. The mixture may also be in liquid form, e.g., dissolved in water.

In an especially preferred embodiment, the present invention relates to a mixture of the type defined above, such that this mixture contains 0.05 to 5% by weight L-carnitine, preferably 0.1 to 5% by weight L-carnitine, 0.1 to 4% by weight L-carnitine, 1 to 5% by weight L-carnitine, or 0.5 to 3% by weight L-carnitine (based on the total dry solids content of the mixture).

In another preferred embodiment, the present invention relates to a mixture as defined above such that this mixture contains at least 0.1% by weight, preferably 10, 20, 30, 40, 50, 60, 70, 80, 90, 95, 96, 97, 98 or 99% by weight, or 99.5 to 99.9% by weight, low-glycemic sucrose isomer. This mixture may also contain preferably 5 to 80% by weight low-glycemic sucrose isomer, especially 50 to 75% by weight or 10 to 60% by weight low-glycemic sucrose isomer (each based on the total dry solids of the mixture).

In particular, the present invention relates to the mixture specified above, containing 0.05 to 5% by weight L-carnitine and at least 0.1% by weight, preferably 10, 20, 30, 40, 50, 60, 70, 80, 90% by weight, or 95% by weight to 99.95% by weight, low-glycemic sucrose isomer. This mixture may also contain preferably 0.1 to 4% by weight L-carnitine and at least 0.1% by weight, preferably 10, 20, 30, 40, 50, 60, 70, 80, 90% by weight, preferably 96% by weight to 99.9% by weight, low-glycemic sucrose isomer, preferably 0.1 to 4% by weight L-carnitine and at least 5% by weight, preferably 10, 20, 30, 40, 50, 60, 70, 80, or 90% by weight, preferably 96% by weight to 99.9% by weight, low-glycemic sucrose isomer. This mixture may also contain preferably 0.1 to 4% by weight L-carnitine and 50% by weight, preferably 96% by weight to 99.9% by weight, low-glycemic sucrose isomer; or 0.1 to 4% by weight L-carnitine and at least 10% by weight, preferably 96% by weight to 99.9% by weight, low-glycemic sucrose isomer (each based on the total dry solids of the mixture).

In another preferred embodiment, the present invention relates to a mixture as specified above, such that this mixture contains 0.1 to 5% by weight, preferably 0.5 to 4% by weight L-carnitine and at least 0.1% by weight, preferably 10, 20, 30, 40, 50, 60, 70, 80, 90% by weight, preferably 95% by weight to 99.9% by weight, low-glycemic sucrose isomer and/or 96% by weight to 99.5% by weight low-glycemic sucrose isomer. This mixture may also contain preferably 0.5 to 3% by weight L-carnitine and 97 to 99.5% by weight low-glycemic sucrose isomer, or preferably 0.5 to 4% by weight L-carnitine and at least 50% by weight, preferably 96% by weight to 99.5% by weight; or 0.5 to 4% by weight L-carnitine and at least 10% by weight, preferably 96% by weight to 99.5% by weight, low-glycemic sucrose isomer (each based on the total dry solids of the mixture).

In another preferred embodiment, the inventive mixture comprises, aside from L-carnitine and the at least one low-glycemic sucrose isomer, at least one additive, in particular in an amount equal to 1 to 99% by weight, preferably 2 to 85% by weight, 3 to 70% by weight, 5 to 60% by weight, 10 to 50% by weight, 20 to 40% by weight, or 25 to 38% by weight, based on the total dry weight of the mixture.

A supplement shall be taken to mean substances affecting, in particular, the appearance, flavor, organoleptic properties, nutritional value, physiological nutritional properties, processability, shelf-life or readiness for use of the mixture.

In another preferred embodiment, the at least one additive is a prebiotic.

In another preferred embodiment, the at least one additive is a probiotic.

In another preferred embodiment, the at least one additive is a supplement.

In another preferred embodiment, the at least one additive is a component containing fat.

In another preferred embodiment, the at least one additive is a milk product.

In another preferred embodiment, the at least one additive is a sweetening agent.

In conjunction with the present invention, the term “sweetening agent” is understood to include substances that possess a sweetening power and are added, for example, to foods or beverages in order to produce a sweet flavor.

In conjunction with the present invention, the “sweetening agents” shall be subdivided into “sugars,” such as isomaltulose, sucrose, glucose or fructose, that are bodying substances with sweetening power, and “sweeteners,” i.e., substances that are not sugars but still possess sweetening power, with the latter being further subdivided as “sugar substitutes,” i.e., bodying sweeteners having a physiological caloric value in addition to sweetening power (bodying sweetener), and as “intense sweetener,” i.e., substances that usually have very high sweetening power, but no bodying effect and usually no or little physiological caloric value. For example, sucralose is an intense sweetener.

Accordingly, in an especially preferred embodiment, the sweetening agent is a sugar, an intense sweetener or a sugar substitute.

In another preferred embodiment, the intense sweetener is selected from the group comprising sucralose, sodium cyclamate, acesulfame K, neohesperidine dihydrochalcone, glycyrrhizine, stevioside, monellin, thaumatin, aspartame, dulcin, saccharine, naringin dihydrochalcone, neotame, and a mixture of two or more of these. In another preferred embodiment of the invention, the sugar substitute is selected from the group comprising isomalt, 1,1-GPM (1-O-α-D-glucopyranosyl-D-mannitol), 1,6-GPS (6-O-α-D-gluco-pyranosyl-D-sorbitol), 1,1-GPS (1-O-α-D-glucopyranosyl-D-sorbitol), maltodextrins, lactitol, maltitol, erythritol, xylitol, mannitol, sorbitol, maltitol syrup, hydrogenated and non-hydrogenated starch hydrolysates, and a mixture of two or more of these.

In another preferred embodiment, the at least one additive is a sugar, in particular sucrose, glucose, fructose, lactose, maltose or a mixture of two or more of these.

The present invention of course also relates to mixtures containing L-carnitine and the at least one low-glycemic sucrose isomer, such that the at least one low-glycemic sucrose isomer is the only bodying sweetening agent present in the mixture. In another preferred embodiment, the invention relates to a mixture as specified above containing L-carnitine and the at least one low-glycemic sucrose isomer, such that the at least one low-glycemic sucrose isomer is the only sugar present in the mixture. In another preferred embodiment, the present invention relates to a mixture containing L-carnitine and the at least one low-glycemic sucrose isomer, such that the at least one low-glycemic sucrose isomer is the only sweetening agent present in the mixture.

The invention relates, in particular, to a mixture containing or comprising L-carnitine and the at least one low-glycemic sucrose isomer and a product containing this mixture, such that the mixture and/or the product are suitable for diabetics.

In another preferred embodiment, the present invention relates to a mixture as specified containing L-carnitine and the at least one low-glycemic sucrose isomer, such that this mixture is free of sucrose, is free of glucose, is free of lactose, is free of fructose, is free of sorbitol, is free of xylitol, is free of mannitol or is free of one or more or all of the sugars or sugar alcohols specified above.

In another preferred embodiment, the present invention relates to a mixture containing L-carnitine and the at least one low-glycemic sucrose isomer, such that this mixture contains a prebiotic, in particular insulin, oligofructose or galactooligosaccharides, as an additive.

In another preferred embodiment, the present invention relates to a mixture containing L-carnitine and the at least one low-glycemic sucrose isomer, such that the at least one additive is a milk product, in particular a lactose-free milk product, e.g., skim milk powder, whole milk powder, lactose-free skim milk powder, lactose-free whole milk powder, a whey product or a mixture of two or more of these.

In another preferred embodiment, the present invention relates to a mixture containing L-carnitine and the at least one low-glycemic sucrose isomer, such that the at least one additive is a supplement selected from the group comprising malt extract, flavoring substances, dyes, flavorings, flow aids, minerals such as sodium and calcium, in particular salts such as sodium chloride, vitamins, folic acid, emulsifiers, dietary fiber, lecithin, omega-3 fatty acids, medium-chain-length triglycerides, phytoestrogens, and ascorbic acid salts.

In another preferred embodiment, the invention relates to a mixture containing L-carnitine and the at least one low-glycemic sucrose isomer, such that a probiotic, e.g., Lactobacteria or Bifidobacteria, is present as an additive.

In a special embodiment, the invention preferably relates to one of the present mixtures which is free of garcinia extract, i.e., in particular free of an extract from the bark of garcinia, e.g., Garcinia cambogia, Garcinia indica, Garcinia atrovirides or the like.

In another preferred embodiment, the inventive mixture is free of caffeine.

In an especially preferred embodiment of the present invention, the inventive mixture is free of caffeine and garcinia extract.

The invention also relates to products containing at least one of the mixtures specified above and preferably at least one of the additives specified above, i.e., for example, a prebiotic, a probiotic, a supplement, a fat-based ingredient, a milk product or a sweetening agent.

In an especially preferred embodiment, the products are solid or liquid products.

In an especially preferred embodiment of the present invention, the product is a liquid product, in particular a product containing at least one of the mixtures specified above and a solvent, such as water or milk. The beverages may be alcoholic or non-alcoholic beverages. In a preferred embodiment, the beverages are suitable for diabetics. In an especially preferred embodiment, the product is a beverage, e.g., a sports beverage, an energy drink, an enteral formulation, a refreshment beverage, a beverage containing cola or similar.

An especially preferred embodiment provides that the beverage contains 2 to 40% by weight, preferably 3 to 35% by weight, preferably 4 to 30% by weight, or preferably 10 to 30% by weight of the mixture (each based on the total weight of the beverage).

In another preferred embodiment, the inventive mixture is contained in a product that is provided as food, luxury food or drug.

According to the invention, the use of the inventive mixture in a food, luxury food or drug is preferred, such that the food, luxury food or drug contains 1 to 99% by weight, 2 to 99% by weight, preferably 20 to 70% by weight, preferably 30 to 60% by weight, or more preferably 40 to 55% by weight (based on the total dry solids of the food, luxury food or drug) of the mixture. In a particular embodiment, the food, luxury food or drug is free of glucose, fructose, lactose, sucrose, sorbitol, xylitol and/or mannitol. However, according to the invention it may also contain glucose, fructose, sucrose and/or other sweetening agents.

In conjunction with the present invention, the term “food(s)” shall be taken to mean products or substance mixtures in solid, liquid, dissolved or suspended form, the main function of which is to provide for human nutrition and which are destined mainly to be consumed by humans in unchanged form or in a prepared or processed state. Aside from their natural constituents, foods may contain additional components that may be of natural or synthetic origin. Foods may be provided in solid form or in liquid form. A “luxury food” is understood to mean substances or substance mixtures in solid, liquid, dissolved or suspended form that serve mainly for enjoyment by humans or animals, when consumed by them.

In a preferred embodiment of the invention, the foods according to the invention are dairy products or milk products, e.g., cheese, butter, yoghurt, kefir, creamed cheese, sour milk, butter milk, cream, condensed milk, dry milk, whey, mixed milk, half-and-half, mixed whey, milk sugar, milk protein, and milk fat products. In another preferred embodiment of the invention, the foods according to the invention are baked goods, in particular bread, including biscuits/cookies and fine baked goods, including baked goods with a long shelf-life. In additional embodiments of the invention, the foods according to the invention are bread spreads, margarine products and baking fats as well as instant products and broth products. In additional preferred embodiments of the invention, the foods according to the invention are fruit products, in particular jams, marmalades, jellies, fruit preserves, fruit pulp, fruit purée, fruit juices, fruit juice concentrates, fruit nectar, and fruit powder. According to the invention, the foods containing the products according to the invention may also be vegetable products, in particular vegetable preserves, vegetable juices and vegetable pulp. A food according to the present invention may also be a beverage powder, e.g., an instant beverage powder, e.g., a cocoa, tea or coffee beverage powder.

The term “luxury foods” is understood to mean, for example, sweets, in particular chocolate products, hard caramels, soft caramels, fondant products, jelly products, licorices, marshmallow products, coconut flakes, sugar-coated pills, compressed products, candied fruit, croquant (peanut brittle), nougat products, ice cream confections, marzipan, chewing gum, granola bars, and ice cream.

In conjunction with the present invention, “dietetic foods or beverages” are taken to mean foods or beverages that are destined to serve a certain nutritional purpose in that they effect the supply of certain nutrients or other substances with a physiological nutritional effect at a certain quantity ratio or certain consistency. Dietetic foods or beverages differ significantly from foods or beverages of a comparable type by their composition or by their properties. Dietetic foods may be used in cases, in which certain nutritional requirements due to diseases, functional disorders or allergic reactions to individual foods or their constituents must be met. Dietetic foods may be provided in solid or liquid form (beverage).

The invention also relates to methods for the production of the mixtures and products specified above. Therefore, according to the invention, a method for producing the mixtures specified above is to be provided, in which L-carnitine and the at least one low-glycemic sucrose isomer are provided and mixed with each other at the desired ratio.

Another preferred embodiment provides for the production of a product containing this mixture, in which the desired constituents of this product, L-carnitine and the at least one low-glycemic sucrose isomer are provided, and contacted with each other, and the desired product is obtained using the production conditions that are generally known to a person skilled in the art.

In another preferred embodiment, the present invention relates to the use of the at least one low-glycemic sucrose isomer, in particular isomaltulose and/or leucrose, in a product containing L-carnitine to improve the flavor or mask the flavor of the L-carnitine contained in the product.

The invention also relates to the use of at least one low-glycemic sucrose isomer, in particular isomaltulose and/or leucrose, in a product containing L-carnitine to increase the stability of carnitine in the product, in particular in a beverage.

Additional advantageous developments of the invention are evident from the dependent claims.

The present invention will now be explained in greater detail on the basis of the following examples and the respective figure.

### BRIEF DESCRIPTION OF THE DRAWING

FIG. 1 illustrates the taste profile of aqueous solutions containing isomaltulose (Palatinose™) and L-carnitine as well as the reference solutions.

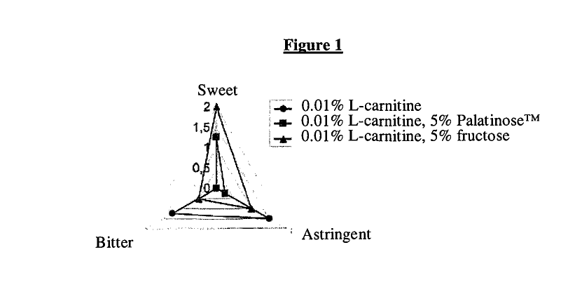

### EXAMPLES

### Example 1

Taste Profile of Aqueous Solutions Containing L-Carnitine

Samples: Sample 1: 0.01% L-carnitine
Sample 2: 0.01% L-carnitine, 5% Palatinose™
Sample 3: 0.01% L-carnitine, 5% fructose

Result:

The samples were tasted by experienced taste testers. The following statistically confirmed results as illustrated in the figure were obtained. It was found with a high significance that the aqueous solution containing L-carnitine as the only ingredient that affects taste is much more bitter and astringent than the two other solutions containing sugars. Surprisingly, the L-carnitine solution containing isomaltulose (Palatinose™) was found to mask both the bitterness and the astringent component of L-carnitine much better than fructose, although the solution containing fructose is definitely much sweeter than the solution containing isomaltulose. The masking effect of isomaltulose therefore cannot be based on the increased sweetening power of the fructose or at least not exclusively.

### Example 2

Stability of Isomaltulose Solutions Containing L-Carnitine

With regard to the chemical stability of isomaltulose solutions containing carnitine, heating tests were performed. Then for comparison purposes the same tests were also performed with fructose. In the analysis, special emphasis was placed on the reaction products, which are often responsible for discoloration and an off-taste (unwanted taste components), even when present in very small amounts.

Test Conditions:
Model solution A: Palatinose solution (10%)+0.5% carnitine
Model solution B: fructose solution (10%)+0.5% carnitine
Temperature 80° C.
Heating time 2 hours

HPLC analysis has confirmed that the isomaltulose solution containing carnitine may be regarded as very stable chemically. The byproducts that form as a result of this test amounted to 0.007 g/100 mL. The fructose solution containing carnitine that was treated under the same conditions had a definitely elevated level of byproducts amounting to 0.031 g/100 mL.

These results show that isomaltulose is especially suitable for the production of products containing carnitine because their stability is surprisingly much higher than that of comparable L-carnitine solutions.

### Example 3

### Recipe for an Orange Beverage

Isomaltulose instant orange beverage containing L-carnitine

| Item | Additives | Amount |
|---|---|---|
| 1 | Palatinose ™ | 92.56% |
| 2 | Citric acid (anhydrous) | 4.96% |
| 3 | Trisodium citrate | 0.26% |
| 4 | Tricalcium phosphate | 0.22% |
| 5 | Vitamin C | 0.24% |
| 6 | Opacifier with dye E 171 | 0.48% |
| 7 | Dye E 102 (85%) | 0.01% |
| 8 | Dye E 110 (85%) | 0.016% |
| 9 | Gum arabic (spray dried) E 414 | 0.10% |
| 10 | Xanthan E 415 | 0.10% |
| 11 | Sodium carboxymethyl cellulose E 466 | 0.10% |
| 12 | Orange flavoring type 100 | 0.64% |
| 13 | Orange flavoring type 120 | 0.24% |
| 14 | Sucralose | 0.03% |
| 15 | L-Carnitine | 0.04% |
| Total | | 100.0% |

### Example 4

### Recipe for a Sports Beverage

Isomaltulose sport drink containing L-carnitine

| Item | Additives | Amount |
|---|---|---|
| 1 | Palatinose ™ | 89.84% |
| 2 | Citric acid (anhydrous) | 6.360% |
| 3 | Vitamin C | 0.550% |
| 4 | Trisodium citrate | 1.194% |
| 5 | Opacifier with dye E 171 | 0.262% |
| 6 | Xanthan E 415 | 0.091% |
| 7 | Sodium carboxymethyl cellulose E 466 | 0.091% |
| 8 | Sucralose | 0.300% |
| 9 | Dye E 102 (85%) | 0.018% |
| 10 | Grapefruit-lemon flavoring | 1.090% |
| 11 | L-Carnitine | 0.200% |
| Total | | 100.0% |

### Example 5

### Recipe for an ACE Beverage

Isomaltulose ACE drink containing L-carnitine

| Item | Additives | Amount |
|---|---|---|
| 1 | Palatinose ™ | 94.50% |
| 2 | Citric acid (anhydrous) | 3.88% |
| 3 | Trisodium citrate | 0.27% |
| 4 | Tricalcium phosphate | 0.25% |
| 5 | Opacifier with dye E 171 | 0.30% |
| 7 | Dye E 110 (85%) | 0.033% |
| 8 | Dye E 102 (85%) | 0.0125% |
| 9 | Dye coffee brown TF 8 | 0.0025% |
| 10 | Dye E 129 (Allura red) | 0.0015% |
| 11 | Vitamin E | 0.02% |
| 12 | Provitamin A | 0.032% |
| 13 | Xanthan E 415 | 0.170% |
| 14 | Sodium carboxymethyl cellulose E 466 | 0.170% |
| 15 | Combination fruit flavoring | 0.330% |
| 16 | L-Carnitine | 0.020% |
| Total | | 100.00% |

All references cited and/or discussed in this specification are incorporated herein by reference in their entireties and to the same extent as if each reference was individually incorporated by reference.

1. A mixture comprising 0.05 to 5% by weight L-camitine and at least one low-glycemic sucrose isomer present in a total amount of at least 2% by weight, each based on the total weight of dry solids in the mixture.

2. The mixture according to claim 1, wherein the low-glycemic sucrose isomer is isomaltulose or leucrose.

3. (canceled)

4. The mixture according to claim 1, wherein the mixture comprises at least one additive.

5. The mixture according to claim 1, wherein the at least one additive is a prebiotic, a probiotic, a supplement, a fat-based ingredient, a dairy product, or a sweetening agent.

6. The mixture according to claim 1, wherein the sweetening agent is a sugar, an intense sweetener, or a sugar substitute.

7. The mixture according to claim 1, wherein the prebiotic is insulin, oligofructose, and/or galactooligosaccharides.

8. The mixture according to claim 1, wherein the intense sweetener is selected from sucralose, sodium cyclamate, acesulfame K, neohesperidine dihydrochalcone, glycyrrhizine, stevioside, monellin, thaumatin, aspartame, dulcin, saccharine, naringin-dihydrochalcone, neotame, and a mixture of two or more of these.

9. The mixture according to claim 1, wherein the sugar substitute is selected from isomalt, 1,1-GPM (1-O-α-D-glucopyranosyl-D-mannitol), 1,6-GPS (6-O-α-D-glucopyranosyl-D-sorbitol), 1,1-GPS (1-O-α-D-glucopyranosyl-D-sorbitol), maltodextrins, lactitol, maltitol, erythritol, xylitol, mannitol, sorbitol, maltitol syrup, hydrogenated and non-hydrogenated starch hydrolysates, and a mixture of two or more of these.

10. The mixture according to claim 1, wherein the at least one additive is a sugar or a mixture of two or more sugars.

11. The mixture according to claim 1, wherein the at least one additive is a dairy product.

12. The mixture according to claim 1, wherein the dairy product is skim milk powder, whole milk powder, lactose-free skim milk powder, lactose-free whole milk powder, a whey product or a mixture of two or more of these.

13. The mixture according to claim 1, wherein the at least one additive is a supplement selected from malt extract, flavoring substances, dyes, flavorings, flow aids, minerals, salts, vitamins, folic acid, emulsifiers, dietary fiber, lecithin, omega-3 fatty acids, medium-chain-length triglycerides, phytoestrogens, and ascorbic acid salts.

14. The mixture according to claim 7, wherein the probiotic is Lactobacilli or Bifidobacteria.

15. The mixture according to claim 1, wherein the low-glycemic sucrose isomer is the only bodying sweetening agent present in the mixture.

16. The mixture according to claim 1, wherein the low-glycemic sucrose isomer is the only sugar present in the mixture.

17. The mixture according to claim 1, wherein the low-glycemic sucrose isomer is the only sweetening agent present in the mixture.

18. The mixture according to claim 1, wherein more than one additive is present.

19. The mixture according to claim 1, wherein the mixture comprises 50 to 75% by weight low-glycemic sucrose isomer based on the total dry weight of the mixture.

20. The mixture according to claim 1, wherein the mixture comprises 1 to 5% by weight L-carnitine based on the total dry weight of the mixture.

21. A product comprising a mixture according to claim 1.

22. The product according to claim 21, wherein the product is a food, luxury food, or drug.

23. The product according to claim 22, wherein the food, luxury food, or drug comprises 2 to 99% by weight of a mixture comprising 0.05 to 5% by weight L-camitine and at least one low-glycemic sucrose isomer present in a total amount of at least 2% by weight, each based on the total weight of dry solids in the mixture.

24. The product according to claim 21, wherein the product is a tablet, a compressed product, an energy bar, a chewing gum, a hard caramel, a soft caramel, a chocolate, a cookie, a baked good, a chocolate bar, a granola bar, a cereal product, a coffee, tea, or cocoa instant formulation.

25. A product produced from and comprising a mixture according to claim 1 and a solvent.

26. The product according to claim 25, wherein the solvent is water or milk.

27. The product according to claim 25, wherein the product is a beverage.

28. The product according to claim 27, wherein the beverage comprises 2 to 40% by weight of a mixture comprising 0.05 to 5% by weight L-carnitine and at least one low-glycemic sucrose isomer present in a total amount of at least 2% by weight, each based on the total weight of dry solids in the mixture.

29. The product according to claim 27, wherein the beverage is a sports beverage, a beverage containing cola, an energy drink, an enteral formulation, or a refreshment beverage.

30. The product according to claim 21 comprising at least one additive.

31. A method of improving or masking the flavor of L-carnitine in a product comprising including a low-glycemic sucrose isomer in a product containing L-carnitine.

32. A method of increasing the stability of L-carnitine in a product comprising including a low-glycemic sucrose isomer in a product containing L-carnitine.

33. The mixture of claim 1, wherein the at least one low-glycemic sucrose isomer is present in a total amount of 95 to 99.9% by weight.

34. The mixture of claim 10, wherein the sugar is selected from sucrose, glucose, fructose, lactose, and maltose.

35. The mixture of claim 11, wherein the dairy product is lactose-free.

36. The mixture of claim 13, wherein the minerals are selected from sodium and calcium.

37. The mixture of claim 13, wherein the salt is sodium chloride.

38. The method of claim 31, wherein the product comprises a mixture comprising 0.05 to 5% by weight L-camitine and at least one low-glycemic sucrose isomer present in a total amount of at least 2% by weight, each based on the total weight of dry solids in the mixture.

39. The method of claim 32, wherein the product comprises a mixture comprising 0.05 to 5% by weight L-camitine and at least one low-glycemic sucrose isomer present in a total amount of at least 2% by weight, each based on the total weight of dry solids in the mixture.
